(19) United States
(12) Patent Application Publication
(10) Pub. No.: US 2015/0300400 A1
(43) Pub. Date: Oct. 22, 2015

(54) COMPONENT FOR FASTENING ON A CARRIER COMPONENT OF AN AUTOMOBILE

(71) Applicant: ILLINOIS TOOL WORKS, INC., Glenview, IL (US)

(72) Inventors: Michael LIEVEN, Stuttgart (DE); Alexander LIMPERT, Weikersheim (DE)

(21) Appl. No.: 14/439,236

(22) PCT Filed: Nov. 14, 2013
(86) PCT No.: PCT/IB2013/002536

§ 371 Date: Apr. 29, 2015

(30) Foreign Application Priority Data
Nov. 14, 2012 (DE) 10 2012 022 239.4

(51) Int. Cl. F16B 39/28

(52) U.S. Cl. CPC F16B 39/28

(57) ABSTRACT

Component for fastening on a carrier component of an automobile, including at least one fastening element, with which the component can be fastened on the carrier component, wherein the component includes at least one through opening, wherein the at least one fastening element includes a flange section, also having a through opening, for abutting on a surface of the component surrounding the at least one through opening of the component, and an insertion section, extending from the flange section for a threaded bolt of the carrier component guided through the through openings of the component and the flange section, wherein the insertion section includes at least one catching device for catching on the thread of the threaded bolt, wherein the surface of the flange section facing away from the insertion section includes several projections and the surface of the component coming into abutment with the flange section includes at least one projection.

The present invention relates to a component for fastening on a carrier component of an automobile, comprising at least one fastening element, with which the component can be fastened on the carrier component, wherein the component comprises at least one through opening, wherein the at least one fastening element comprises a flange section, also having a through opening, for abutting on a surface of the component surrounding the at least one through opening of the component, and an insertion section, extending from the flange section for a threaded bolt of the carrier component guided through the through openings of the component and the flange section, wherein the insertion section comprises at least one catching device for catching on the thread of the threaded bolt.

Such components may be a matter of lining components for the body of an automobile, for instance. Corresponding to this, the carrier component may be a body part of an automobile. Fields of utilization are e.g. undershields for the body of an automobile or so-called wheel arch liners for the wheel arches of an automobile.

The carrier components have often threaded bolts for fastening the lining components. From the document DE 10 2010 024 870 A1, a device for fastening a component on a threaded bolt is known. The known device is formed in two parts and comprises a holding element and a holding disc, which are connected with each other in the assembled state. The component to be fastened is held between these two parts, and is plugged onto a threaded bolt of a carrier component together with the device. The holding disc has fastening projections on a flange section, which are shaped like cones or pyramids e.g. and which dig into the side of the component associated to them. Thus, it is intended to provide an anti-twist lock. However, the design of the known device in two parts results in a certain lavishness with respect to the production of the device and the mounting thereof. Beside, it has proven that an anti-twist lock can be ensured only up to a certain degree by the fastening projections. From the document WO 2010/110985 A1, a bolt holder arrangement with a catching device for catching on the thread of the threaded bolt is also known.

Starting from the explained state of the art, the present invention is based on the task to provide a component of the kind mentioned in the beginning, which can be produced and fastened on a carrier component in a simple way, and by which an anti-twist lock is always safely provided.

The present invention achieves this task by the subject matter of claim 1. Advantageous embodiments will be found in the dependent claims, the description and the figures.

The present invention achieves the task by a component for fastening on a carrier component of an automobile, comprising at least one fastening element, with which the component can be fastened on the carrier component, wherein the component comprises at least one through opening, wherein the at least one fastening element comprises a flange section, also having a through opening, for abutting on a surface of the component surrounding the at least one through opening of the component, and an insertion section, extending from the flange section for a threaded bolt of the carrier component guided through the through openings of the component and the flange section, wherein the insertion section comprises at least one catching device for catching on the thread of the threaded bolt, wherein the surface of the flange section facing away from the insertion section comprises several projections and the surface of the component coming into abutment with the flange section comprises at least one projection, or wherein the surface of the flange section facing away from the insertion section comprises at least one projection and the surface of the component coming into abutment with the flange section comprises several projections, and wherein the projections engage one another when the fastening element is held on the component such, that the at least one fastening element is secured against a rotation relative to the component.

The fastening element forms a fastening nut, no inner thread being provided in the insertion section however, but a catching device for catching on the outer thread of the threaded bolt. Thus, the fastening element can be just simply plugged up onto the bolt, which facilitates the mounting. No additional holding disc or a similar second component is needed in this. The insertion section of the fastening element can be sleeve-shaped, essentially hollow-cylindrical for instance. The flange section can be disc-shaped. It has a through opening which is arranged centrally, e.g. In the condition of the at least one fastening element when it is held on the component, the through openings of the flange section and the component fall in line, so that they can be plugged up onto the threaded bolt(s) together. The component is normally held on the carrier component by several such fastening elements, wherein the carrier component has then correspondingly several threaded bolts.

For dismounting the component, the at least one fastening element can be detached by unscrewing from the threaded bolt, and thus from the carrier component. However, undesired detachment by a rotation of the at least one fastening element, caused by vibrations in the operation of the automobile e.g., must be avoided. According to the present invention, projections are provided on the surfaces of flange section and component which face each other in the mounted condition. It is possible in this that only one projection is provided on one of the two facing surfaces, and several projections are provided on the other one of the two facing surfaces, for instance two, or even more than two projections. But it is also possible that a plurality of projections is provided on each of the two facing surfaces. In case that a plurality of projections is provided, these can be arranged along a circle line on the respective area or surface, e.g.

When the at least one fastening element is being mounted on the component, the projections of the facing surfaces engage one with the other such that one projection at a time is received between two facing projections and is caught through this. Thus, a locking against rotation is secured. In particular, there will be a safe protection against undesired twisting around a rotational axis given by the insertion direction of the threaded bolt into the insertion section. In case that dismounting is desired, this is of course possible however, namely by applying a sufficient torque to bring the projections out of engagement again.

The component can comprise holding means for holding the at least one fastening element. According to one embodiment, the holding means of the component can comprise catching means for catching on the flange section of the at least one fastening element. The catching means can comprise elastic catching tongues. Then, the fastening element can be thrust under the elastic catching tongues with the flange section, so that these subsequently push against the flange section and hold the fastening element on the component through this. For instance, three catching tongues may be provided per fastening element. In order to facilitate the lateral insertion under the catching tongues, one or several mounting ramps can be provided on the surface of the component over which the flange section is thrust, and which subsequently prevent undesired sliding back of the fastening element out of the engagement of the catching tongues. In particular, the holding means of the component can serve for holding the fastening element in a condition wherein it is pre-assembled on the component. Thus, being pre-assembled to the component, the at least one fastening element can be delivered to a mounting location, where it is then pressed against at least one threaded bolt. But it is also possible that the at least one fastening element is not pre-assembled on the component, but is pushed onto a threaded bolt together with the component just only at the mounting location. The rotation lock against unintended twisting off is then in turn secured by the engagement of the projections with each other. The component does not have to comprise holding means in this case.

According to a further embodiment, the catching device of the insertion section can comprise several elastic catching arms which are designed to catch on the thread of the threaded bolt. The elastic catching arms can e.g. protrude into the insertion section in the radial direction, and then they engage into the thread lead of the threaded bolt with their free ends. In principle, the catching arms can be designed as known from the document WO 2010/110985 A1, e.g.

At least some of the projections, in particular all of the projections, can be provided so as to be bar-shaped and/or tooth-shaped. Furthermore, starting from the surface of the flange section facing away from the insertion section and/or starting from the surface of the component, at least some of the projections, in particular all of the projections, can taper and/or have a rounded cross-sectional shape. For instance, tooth-shaped projections can be provided on the flange section, and one or several bar-shaped projections on the surface of the component, or vice versa. By the tapering or rounding, respectively, it is ensured that always one projection arrives between two projections of the facing surface, without that an accurate alignment of the fastening element in the rotational direction is previously necessary for this. In fact, a suitable alignment of the fastening element is ensured automatically by tapering or rounding the projections.

According to a further embodiment, the flange section can be formed by an elastic spring disc. In this way, production tolerances can be compensated.

According to a further embodiment, the extension of the projections engaging with one another in the insertion direction of the at least one threaded bolt into the insertion section can be larger than a thread pitch of the at least one threaded bolt. When the fastening element with the component is being plugged up onto the threaded bolt, there is often a “snapping back” of the fastening element opposite to the mounting direction. However, this snapping back is normally limited to maximally one thread pitch of the threaded bolt. In this embodiment, in the condition wherein the flange section is completely pushed against the surface of the component, the overlap of the projections in the insertion direction of the threaded bolt (that is to say, in the z-direction in particular), is greater than one thread pitch of the threaded bolt. Thus, it is ensured that the projections are still in engagement with each other even in the snapping back, and the anti-twist lock is granted.

According to a further embodiment, the insertion section can be surrounded by an outer protection cap. This prevents e.g. damage of catching arms in the insertion section, for instance by rock fall in the operation of the automobile. The protection cap can form a multi-sided head, for example a hexagon head. Dismounting the fastening element can take place by a corresponding multi-sided tool, a hexagon tool e.g. Of course, other designs of the protection cap are possible for dismounting.

In principle, the component of the present invention can be designed integrally. It can consist of a plastic material, made in a molding process e.g. According to a further embodiment, it can be provided that the protection cap is molded integrally to the fastening element in a plastic molding process and can be pushed from a mounting position, not or not fully surrounding the insertion section, into an operation position, essentially fully surrounding the insertion section, in which operation position it is held fixed on the insertion section. The protection cap can be held fixed on the insertion section by a pressing fit, e.g. But it is also possible that the protection cap is held fixed on the insertion section by catching means. For instance, catching recesses or catching projections can be provided on a wall of the insertion section. Then, corresponding catching recesses or catching projections, respectively, can be provided on a wall of the protection cap. The catching recesses and catching projections can engage to each other by catch, and hold the protection cap fixed on the insertion section through this.

The component can be a lining component of an automobile. The carrier component can be a body part of an automobile. Such a body part can be a body undershield part or a wheel arch of an automobile, e.g. Correspondingly, the lining component can be an undershield or a wheel arch liner in this case, respectively.

The device of the present invention can also comprise the carrier component and the at least one threaded bolt of the carrier component.

An example of the realisation will be explained in more detail by means of figures in the following. They show schematically:

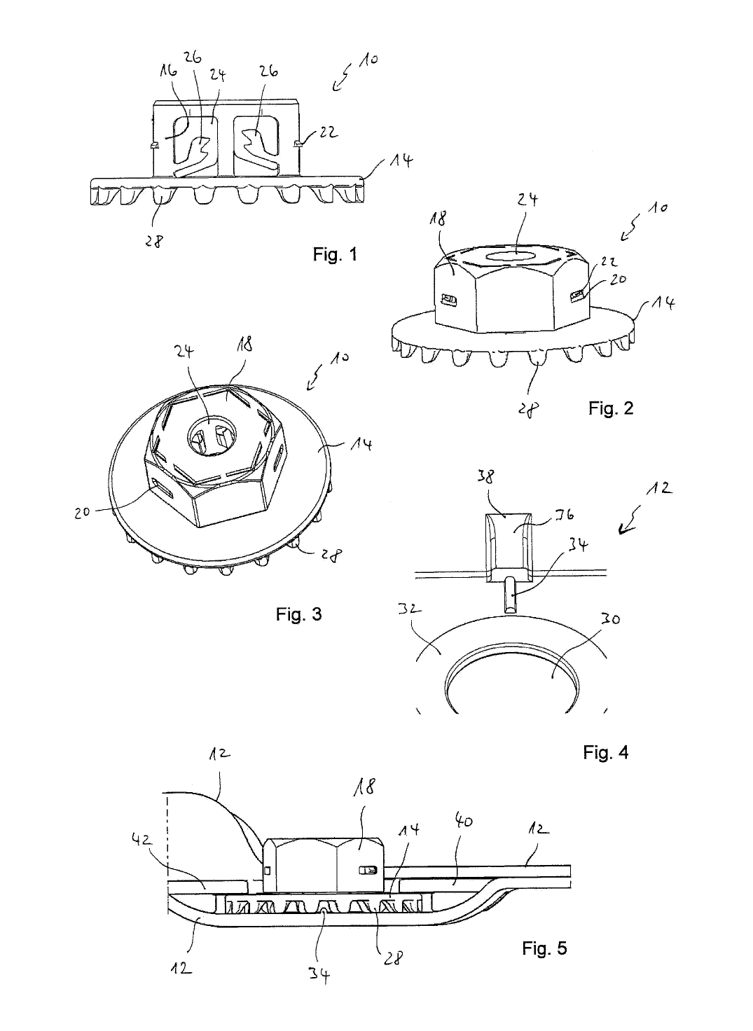

FIG. 1 a part of the fastening element of the present invention, in a side view,

FIG. 2 a fastening element of the present invention with the part of FIG. 1, in a first perspective view,

FIG. 3 the fastening element of FIG. 2 in a second perspective view,

FIG. 4 a component of the present invention in a partial perspective view,

FIG. 5 the fastening element of FIG. 2 in a condition held fixed on the component of FIG. 4, in a partial section view,

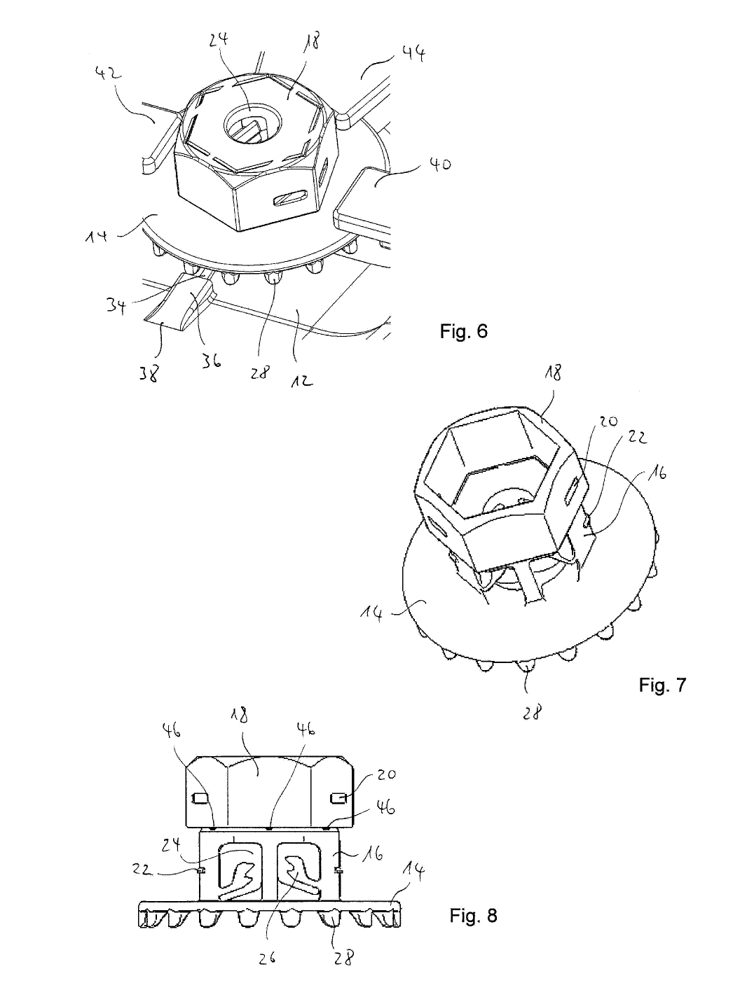

FIG. 6 the fastening element of FIG. 2 in a condition held fixed on the component of FIG. 4, in a partial perspective view,

FIG. 7 the fastening element of FIG. 2 in an off-tool condition in a perspective view, and

FIG. 8 the fastening element of FIG. 7 in a side view.

Insofar as nothing else is indicated, same reference signs designate same objects. In FIGS. 1 to 3, a fastening element 10 of the present invention is shown, by which the component 12, partially shown in FIG. 4, which may be a lining component of an automobile e.g., can be fastened on a carrier component (not shown). The carrier component can be a body part of an automobile, e.g. The fastening element 10 has a flange section 14, which is formed by an elastic spring disc. Starting from the flange section 14 extends an insertion section 16, which is essentially hollow cylindrical in the shown example. In FIGS. 1 and 2, one recognizes that in the completely mounted condition, the insertion section 16 is surrounded by a protection cap 18 forming an external hexagon. For reasons of good illustration, the fastening element 10 is shown without the protection cap in FIG. 1. In the shown example, the protection cap 18 has several catching recesses 20 in its outer wall, into which engage corresponding catching projections 22 of the insertion section 16, so that the protection cap 18 is held fixed on the insertion section 16.

A central through opening 24 extends across the flange section 14, the insertion section 16 and the protection cap 18, from bottom to top in FIG. 1. A not shown threaded bolt of the carrier component can be plugged through this through opening 24. The insertion section 16 has several elastic catching arms 26, two or four for instance, facing each other in pairs, which protrude into the insertion section 16 in the radial direction. The catching arms 26 serve for catching on the thread of the threaded bolt, and for holding the fastening element 10 fixed on the threaded bolt through this. In FIGS. 1 to 3, one recognises in addition that a plurality of tooth-shaped projections 28 are formed on the surface of flange section 14 facing away from the insertion section 16, namely the lower surface of the flange section 14 in FIG. 1. In the shown example, the tooth-shaped projections 28 are formed along a circular path on the outer edge of the corresponding surface of the flange section 14.

A component 12 for fastening on the carrier component is partially shown in FIG. 4. A through opening 30 formed in the component 12 can also be recognized partially, it is limited by an annularly circulating surface 32. One recognizes in addition that a bar-shaped projection 34, extending in the radial direction with respect to the through opening 30, is formed on the top side of the component 12 which can be recognized in FIG. 4. As can be recognized in FIG. 4, the projection 34 has a rounded cross sectional shape, a semi-circular cross sectional shape for instance. A mounting ramp 36 borders the projection 34 in the radial direction outwardly, whose flat starting end 38 is facing away from the through opening 30. As can be recognized e.g. in the partial depiction in FIG. 6, the component 12 has in addition three elastic catching tongues 40, 42, 44 in the shown example, only the free end of each catching tongue 40, 42, 44 being recognizable in FIG. 6. The catching tongues 40, 42, 44 are bound to the surface of the component 12 with their other end, for instance integrally. The three catching tongues 40, 42, 44 are arranged around the through bore 30, essentially in an offset of 90° from each other, wherein the projection 34 and the mounting ramp 36 are in turn in an offset of 90° with respect to the catching tongues.

In the FIGS. 5 and 6, the condition of the fastening element 10 when held on the component 12 is shown. In order to arrive in this mounting position, the fastening element 10 has been thrust across the mounting ramp 36 below the catching tongues 40, 42, 44 with its flange section 14. In this condition, the catching tongues 40, 42, 44 exert a pressing force on the fastening element 10 in the direction of component 12. Through this, the fastening element 10 is somewhat pressed downward in the direction of component 12, so that unwanted thrusting back across the mounting ramp 36 is prevented. Moreover, the bar-shaped projection 34 of the component 12 arrives between two of the tooth-shaped projections 28 of the flange section 14 when the fastening element 10 is being thrust onto the component 12, and thus it is caught between them as can be recognized in the FIGS. 5 and 6. The design of the projections 28, 34, the tooth-shaped design of the projections 28 and the design of the projection 34 as being rounded in its cross sectional shape in particular, ensure that this engagement of the projections 28, 34 with each other takes place even without previous alignment of the fastening element into the rotational direction.

In this condition of the fastening element 10 held on the component 12, the component 12 and the fastening element 10 can be plugged onto a threaded bolt of the carrier component, whereby the component 12 is safely held on the carrier component via the fastening element 10. Several of the fastening elements 10 of the present invention are normally provided on the component 12, so that corresponding to this, several fastening points on the component 12 and corresponding threaded bolts of the carrier component are provided. The projections 28, 34 are preferably selected such that in the condition shown in FIGS. 5 and 6, namely completely pushed onto the component 12, the overlap between the projections 28, 34 in the insertion direction of the threaded bolt, i.e. from bottom to top in FIG. 5, is greater than one thread pitch of the threaded bolt. Thus, it is guaranteed that the anti-twist lock caused by the engagement of the projections 28, 34 into each other is ensured even in a possible slight snapping back of the fastening element 10 from the threaded bolt in the course of mounting.

In the FIGS. 7 and 8, the fastening element 10 shown in FIGS. 1 to 6 is shown in an off-tool condition, i.e. a condition directly after the molding process. The fastening element 10 consists of a plastic material and is produced integrally in a plastic molding process in the present case. As can be recognized in FIGS. 7 and 8, the protection cap 18 surrounding the insertion section 16 is connected to the insertion section 16 via several connection points 46 in this pre-assembly condition, i.e. essentially immediately after the plastic molding process. From out this pre-assembly condition, the protection 18 can be thrust onto the insertion section 16, breaking up the connection points 46, wherein catching of the catching recesses 20 and the catching projections 22, and thereby a fixed seat of the protection cap 18 on the insertion section 16 takes place.

1. Component for fastening on a carrier component of an automobile, comprising at least one fastening element, with which the component can be fastened on the carrier component, wherein the component comprises at least one through opening, wherein the at least one fastening element comprises a flange section, also having a through opening, for abutting on a surface of the component surrounding the at least one through opening of the component, and an insertion section, extending from the flange section for a threaded bolt of the carrier component guided through the through openings of the component and the flange section, wherein the insertion section comprises at least one catching device for catching on the thread of the threaded bolt, wherein
the surface of the flange section facing away from the insertion section comprises several projections and the surface of the component coming into abutment with the flange section comprises at least one projection,
or that the surface of the flange section facing away from the insertion section comprises at least one projection and the surface of the component coming into abutment with the flange section comprises several projections,
wherein the projections engage one another when the fastening element is held on the component such, that the at least one fastening element is secured against a rotation relative to the component.

2. Component according to claim 1, wherein the component comprises holding means for holding the at least one fastening element.

3. Component according to claim 2, wherein the holding means of the component comprise catching means for catching on the flange section of the at least one fastening element.

4. Component according to claim 3, wherein the catching means comprise elastic catching tongues.

5. Component according to claim 1, wherein the catching device of the insertion section comprises several elastic catching arms which are designed to catch on the thread of the threaded bolt.

6. Component according to claim 1, wherein at least some of the projections, in particular all of the projections, are provided bar-shaped and/or tooth-shaped.

7. Component according to claim 1, wherein, starting from the surface of the flange section facing away from the insertion section and/or starting from the surface of the component, at least some of the projections, in particular all of the projections, taper and/or have a rounded cross-sectional shape.

8. Component according to claim 1, wherein the flange section is formed by an elastic spring disc.

9. Component according to claim 1, wherein the extension of the projections engaging with one another in the insertion direction of the at least one threaded bolt into the insertion section is larger than a thread pitch of the at least one threaded bolt.

10. Component according to claim 1, wherein the insertion section is surrounded by an outer protection cap.

11. Component according to claim 10, wherein the protection cap forms a multi-sided head, for example a hexagon head.

12. Component according to claim 10, wherein the protection cap is molded integrally to the fastening element in a plastic molding process and can be pushed from a mounting position, not or not fully surrounding the insertion section, into an operation position, essentially fully surrounding the insertion section, in which operation position it is held fixed on the insertion section.

13. Component according to claim 12, wherein the protection cap is held fixed on the insertion section by catching means.

14. Component according to claim 1, wherein the component is a lining component of an automobile and/or that the carrier component is a body part of an automobile.
